(19) United States
(12) Patent Application Publication
(10) Pub. No.: US 2005/0235798 A1
(43) Pub. Date: Oct. 27, 2005

(54) Cutting segment tip

(76) Inventors: Christoph Weber, Neuheim (CH); Roland Egg, Rankweil (AT)

Correspondence Address: DAVID TOREN, ESQ.;ABELMAN FRAYNE & SCHWAB, 666 THIRD AVENUE, NEW YORK, NY, 10017-5621, US

(21) Appl. No.: 11/098,069

(22) Filed: Apr. 4, 2005

(30) Foreign Application Priority Data
Apr. 5, 2004 (DE) 10 2004 016 819.9

(51) Int. Cl. B27B 13/02; B27B 33/14

(52) U.S. Cl. 83/835

(57) ABSTRACT

A cutting segment tip (10) for a tool, such as core bit, saw blade, separating disc, has a base (11) for securing the cutting segment tip (10) to the tool, and a cutting surface (20) arranged opposite the base (11) and having at least two surface section (21, 22, 23, 24) offset stepwise relative to each other.

### BACKGROUND OF THE INVENTION

1. Field of the Invention

The present invention relates to a cutting segment tip for a tool, such as core bit, saw blade, separating disc, or the like, and having a base for securing the cutting segment tip on the tool, and a cutting surface located opposite the base.

2. Description of the Prior Art

Cutting segment tips of the type described above are generally arranged on a cutting edge or edges of the tool.

European Publication EP 1 236 553 A1 discloses cutting segment tips of the type described above secured on the cutting edge of a cylindrical core bit. The cutting segment tips have each a base surface with which the segment tip is secured on the cutting edge of the core bit. The cutting segments tips further have cutting surfaces that are inclined relative to the respective base surfaces.

The drawback of the cutting segment tip, which is disclosed in EP 1 236 553 A1 consists in that after an extended operation the shape of its cutting surface changes, and the cutting efficiency is reduced.

European Publication EP 0 204-674 discloses a circular saw blade that is provided on its periphery with a plurality of cutting segment tips. Each of the segment tip has a cutting surface that extends substantially parallel to a base over which the segment tip is secured on the circular saw blade.

The drawback of the disclosed segment tip, as in the previously described reference, consists in that after an extended operation, the shape of the cutting surface changes, and the cutting efficiency is reduced.

Accordingly, an object of the present invention is a cutting segment tip in which the above-discussed drawbacks of the known segment tips are eliminated and the cutting efficiency is increased.

### SUMMARY OF THE INVENTION

This and other objects of the present invention, which will become apparent hereinafter, are achieved by providing a cutting surface having at least two surface sections stepwise offset relative to each other.

The stepwise relationship of the two surface sections, i.e., the stepped shape of the cutting surface is retained, at least in a weakened form, during the entire service life of the cutting segment tip. Simultaneously, the cutting segment tip according to the invention retains a substantially uniform cutting efficiency over its entire service life.

According to an advantageous embodiment of the present invention, the cutting surface has more than two surface sections, with all of the surface sections arranged stairwise one after another in an extension direction of the cutting segment tip.

Stairwise means here arranging of the surface sections in form of stairs. A longitudinal axis of a cutting segment tip extends, with the segment tip being secured on a tool, advantageously in a cutting direction or in the displacement path or plane of the tool. The advantage of such a cutting surface consists in that otherwise conventional sharpening of a tool, which is equipped with the inventive cutting segment tip, before the start of the first operation, is eliminated. Further, with the inventive cutting segment tip according to the advantageous embodiment, high cutting speeds become possible. This is because a smaller part of the segment tip penetrates into a cut workpiece.

The advantageous effect of the stairwise arrangement of the surface sections is particularly enhanced when the surface sections lie in planes extending parallel to each other.

It is advantageous when the surface segments are offset stepwise relative to each other in a direction perpendicular to the longitudinal extent of the segment tip, i.e., when the surface sections are stepwise offset in an operational direction. Thereby, stair sections are formed which extend in the operational direction of the segment tip over their entire length. The advantage of this arrangement consists in that otherwise conventional sharpening of a tool, which is equipped with the inventive cutting segment tip, before the start of the first operation, is eliminated. As a result, with the inventive cutting segment tip according to the advantageous embodiment, high cutting speeds are achieved. This is because a smaller part of the segment tip penetrates into a cut workpiece.

According to a further advantageous embodiment of the present invention, two adjacent surface sections are arranged relative to each other at an angle greater than 0°. This provides a quasi-wedge shape of the cutting surface that provides, in turn, for high cutting speeds. With the stepwise arrangement of the surface sections of the cutting surface, it is additionally achieved that the quasi-wedge shape of the segment tip is retained over the entire service life of the segment tip. Advantageously, the angle between the adjacent surface sections is in a range from 10° to 50°.

An easily manufactured cutting segment tip is obtained when the height of the step or of the offset between adjacent surface sections amounts to from 0.1 mm to 5 mm, preferably, to from 0.3 mm to 1 mm.

An advantageous symmetry, in particular of annular cutting segment tips is achieved when the surface sections are inclined to the base at the same angle.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a perspective view of a cutting segment tip according to the present invention;

FIG. 2 a side view of the cutting segment tip shown in FIG. 1 in the direction shown with arrow II;

FIG. 3 a plan view of a cutting surface of the cutting segment tip shown in FIG. 1 in the direction of arrow III;

FIG. 4 a plan view of a core bit with cutting segment tips shown in FIG. 1 in the direction of arrow IV;

FIG. 5 a perspective view of a circular saw blade with cutting segment tips;

FIG. 6 a side view of another embodiment of a cutting segment tip according to the present invention;

FIG. 7 an end side view of a further embodiment of a cutting segment tip according to the present invention shown in FIG. 8 in the direction of arrow VII;

FIG. 8 a perspective view of the cutting segment tip shown in FIG. 7; and

FIG. 9 a perspective view of yet another embodiment of a cutting segment tip according to the present invention.

### DETAILED DESCRIPTION OF THE PREFERRED EMBODIMENTS

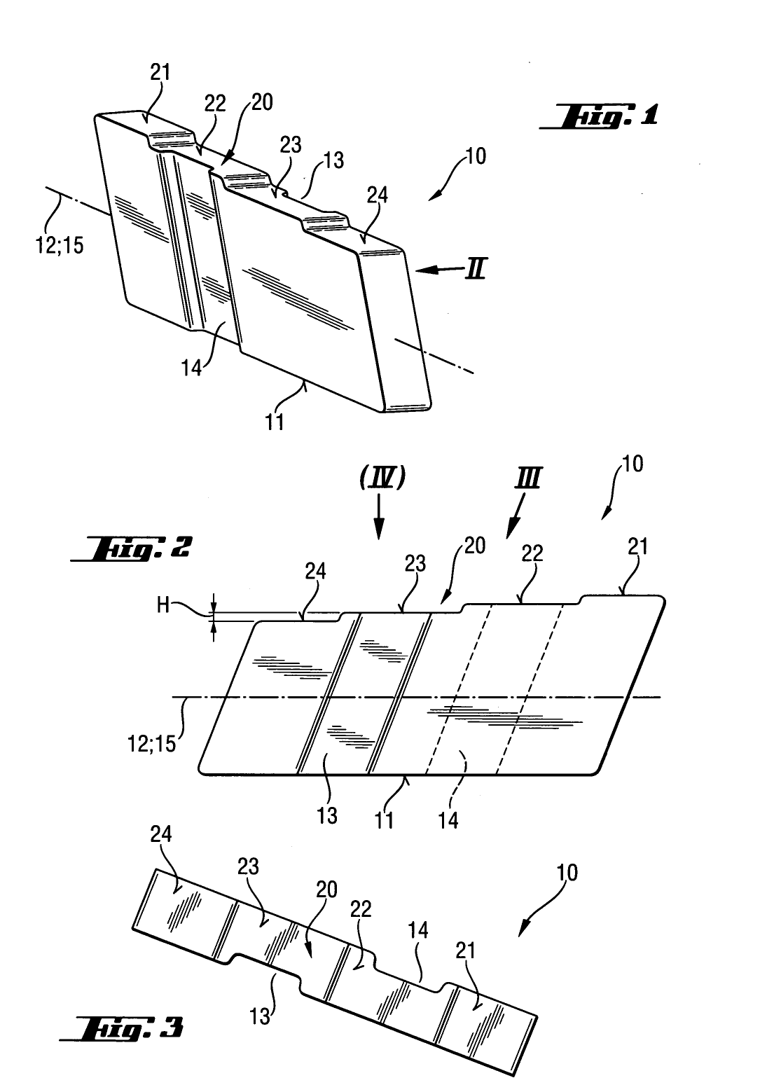

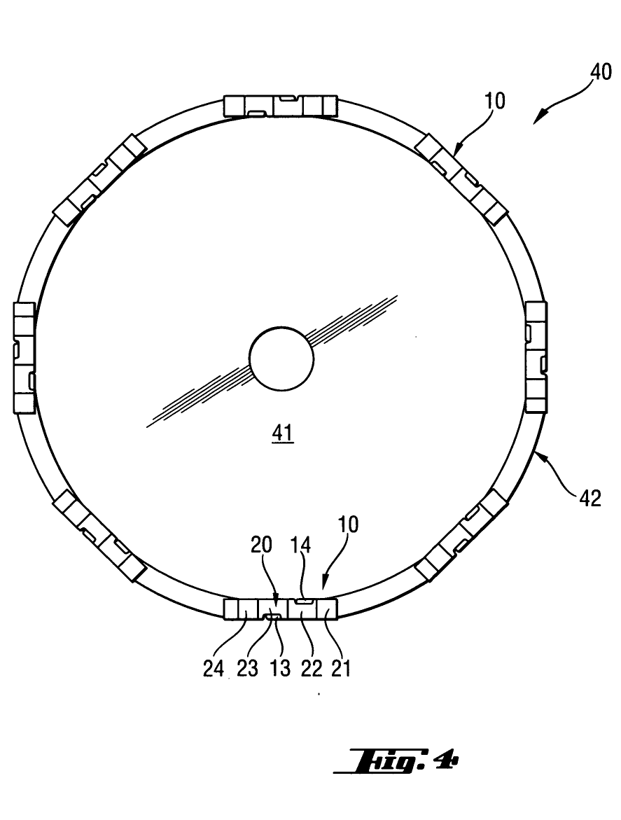

A cutting segment tip 10 according to the present invention, which is shown in FIG. 1-3, is used for tools such as core bit, saw blades, separating discs and has a base 11 for securing the cutting segment tip 10 on an appropriate tool. The cutting segment tip 10 further has a cutting surface spaced from the base 11. Preferably, the cutting segment tip 10 is formed as a composite body formed as a matrix in which cutting particles such as, e.g., diamonds or similar hard or hardened minerals are dispersed. The cutting segment tip 10 has an elongate profile that defines a longitudinal axis 12. Along the longitudinal axis 12 or in an extension direction 15 of the cutting segment tip 10, the cutting surface 20 has a plurality of step- or stair-shaped surface sections 21, 22, 23, 24 which extend in planes lying parallel to each other. The surface sections 21, 22, 23, 24 also extend parallel to the base 11. The surface sections 21, 22, 23, 24 are height-offset relative to each other, with a height between adjacent surface sections varying between 0.1 and 5 mm, preferably, between 0.3 and 1 mm.

In the side surfaces of the cutting segment tip according to the present invention, there is provided, respectively, a groove 13, 14 that serves for both removal of drillings and the drilling mud or for feeding water.

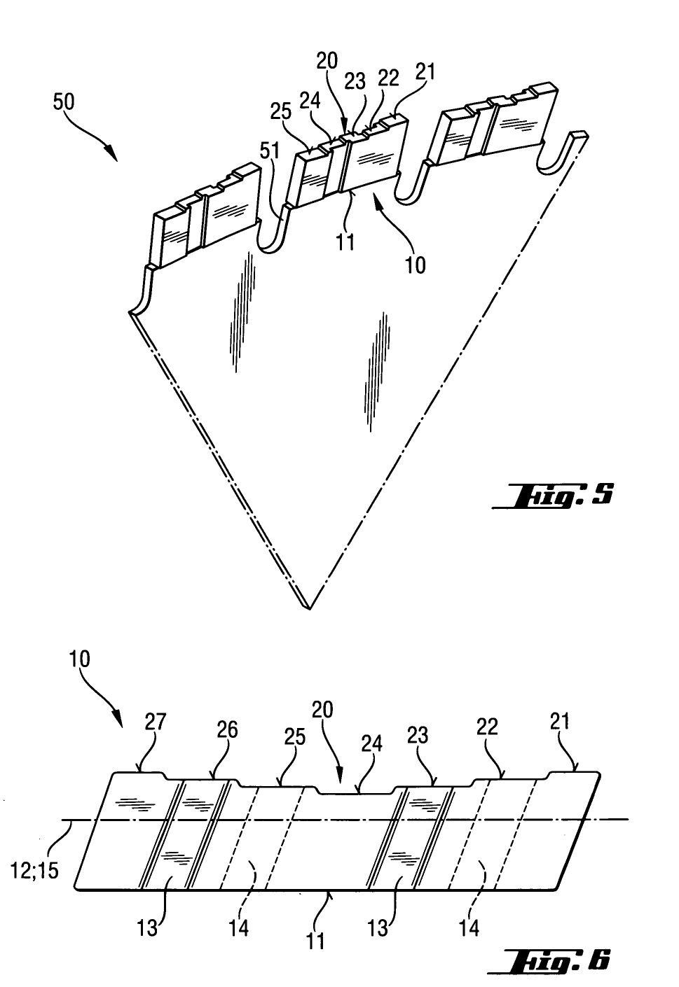

FIG. 4 shows a core bit 40, with a plurality of cutting segment tips 10 according to the present invention arranged along a cutting edge 42 that surrounds a pot-shaped receiving space 41.

FIG. 5 shows a circular saw blade 50, with a cutting segment tip 10 being secured on each of the teeth 51 of the blade 50 with its base 11. The cutting segment tip 10 can be secured to the tooth 51, e.g., with glue, by soldering, or welding. The cutting surface 20 of the cutting segment tip 10 has, as it was described with reference to FIGS. 1-3, five stair-shaped surface sections 21, 22, 23, 24, 26.

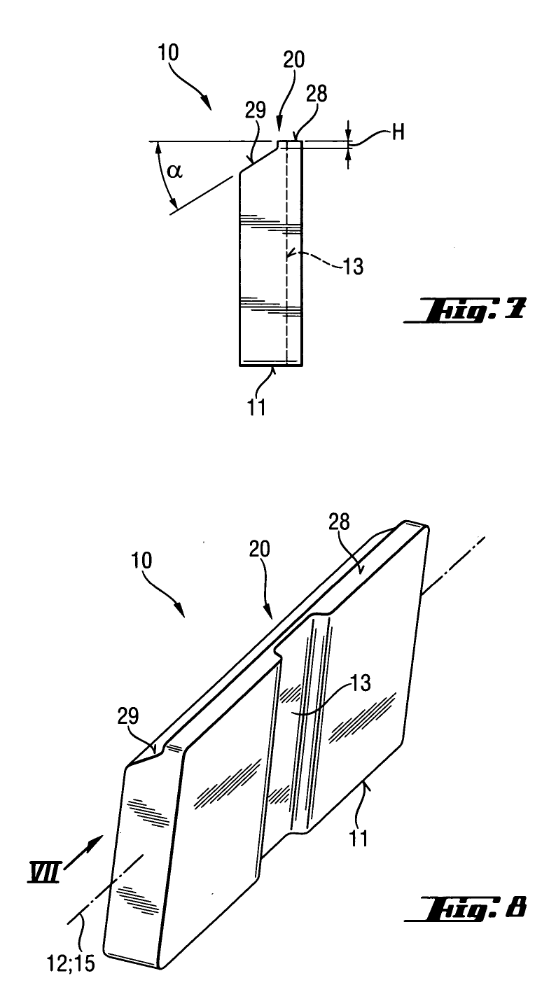

Another embodiment of a cutting segment tip 10 according to the present invention is shown in FIG. 6. In the embodiment of the cutting segment tip 10 shown in FIG. 6, the cutting surface 20 has seven surface sections 21, 22, 23, 24, 25, 26, 27 which starting from a central surface section 24, form an opposite sides from the central surface section 24, steps rising toward the end surfaces of the segment tip 10 along the longitudinal axis 12 or in the extension direction 15. On each of the opposite sides, the cutting segment tip 10, shown in FIG. 6, has two grooves 13, 14 which are slightly inclined from the base 11 toward the cutting surface 20. The cutting surface 20 itself is also slightly inclined in the operational direction.

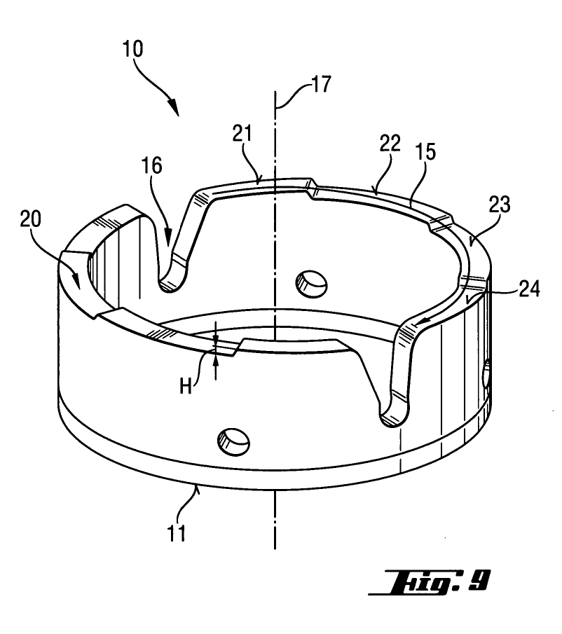

A cutting segment tip 10, which is shown in FIGS. 7-8, has a cutting surface 20 having two surface sections 28, 29 arranged stepwise relative to each other. Both surface sections 28, 29 extend parallel to the longitudinal axis 12 or to the extension direction 15 over the entire longitudinal extent of the cutting segment tip 10. The surface section 28 extends substantially parallel to the base 11 of the cutting segment tip 10. The surface section 29 is inclined at an angle \acute{α} with respect to the surface section 28, preferably, of between 10° and 50°. Both surface sections 28, 29 form a quasi-wedge shape of the cutting surface 20. The cutting segment tip has a groove 13 on one of its side. The step height H lies in a range from 0.1 mm to 5 mm, preferably, in a range from 0.3 mm to 1 mm.

FIG. 9 shows an annular cutting segment tip 10 having a cutting surface 20 which is divided in two parts by two slots 16. The cutting surface 20 has four surface segments 21, 22, 23, 24 arranged stairwise one after another in the extension direction 15 of the cutting segment tip 10. The step height H between separate surface sections 21, 22, 23, 24 here also is in a range from 0.1 mm to 5 mm, preferably, from 0.3 mm to 1 mm. The surface sections 21, 22, 23 24 are inclined toward the base 11, with the inclination angle of all of the surface sections 21, 22, 23, 24 being the same. The surface sections 21, 22, 23, 24 are provided on both parts of the cutting surface 20 and are arranged rotationally-symmetrically along a two-part rotational axis that coincides with a rotational axis 17 of the cutting segment tip 10.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited be limited to the disclosed embodiments or details thereof, and the present invention includes all variations and/or alternatives embodiments within the spirit and scope of the present invention as defined by the appended claims.

1. A cutting segment tip for a tool, comprising a base (11) for securing the cutting segment tip (10) on the tool (40, 50); and a cutting surface (20) arranged opposite the base (11) and having at least two surface sections (21, 22, 23, 24, 25, 26, 27, 28, 29) offset stepwise relative to each other.

2. A cutting segment tip according to claim 1, wherein the cutting surface (20) has more than two surface sections (21, 22, 23, 24, 25, 26, 27), arranged stairwise one after another in an extension direction (15) of the cutting segment tip (10).

3. A cutting segment tip according to claim 1, wherein the cutting surface (20) has more than two surface sections, with all of the surface sections (21, 22, 23, 24, 25, 26, 27), being stairwise offset relative to each other along a longitudinal axis (12) of the cutting segment tip (10).

4. A cutting segment tip according to claim 1, wherein the at least two surface sections (21, 22, 23, 24, 25, 26, 27) lie in respective planes extending parallel to each other.

5. A cutting segment tip according to claim 1, wherein the at least two surface sections (28, 29) are offset stepwise relative to each other in a direction perpendicular to a longitudinal axis (12) of the cutting segment tip (10).

6. A cutting segment tip according to claim 1, wherein the at least two surface sections (28, 29) are arranged at an angle (\acute{α}) greater than 0° relative to each other.

7. A cutting segment tip according to claim 6, wherein the angle (\acute{α}) at which the two surface sections (28, 29) are arranged relative to each other is in a range between 10° and 50°.

8. A cutting segment tip according to claim 1, wherein step between the at least two surface sections (21, 22, 23, 24, 25, 26, 27, 28, 29) has a height (H) that amounts to from 0.1 mm to 5 mm.

9. A cutting segment tip according to claim 8, wherein the step has a height (H) that amounts from 0.3 mm to 5 mm.

10. A cutting segment tip according to claim 1, wherein the at least two surface sections (21, 22, 23, 24) are inclined to the base (11) at a same angle.
